(19) United States
(12) Patent Application Publication
(10) Pub. No.: US 2005/0144784 A1
(43) Pub. Date: Jul. 7, 2005

(54) Electric razor

(76) Inventors: Yasuo Ibuki, Hikone-shi (JP); Mikihiro Yamashita, Hatasho-cho Echi-gun (JP)

Correspondence Address: GREENBLUM & BERNSTEIN, P.L.C., 1950 ROLAND CLARKE PLACE, RESTON, VA, 20191, US

(21) Appl. No.: 10/502,047

(22) PCT Filed: Jun. 10, 2003
(86) PCT No.: PCT/JP03/07308

(30) Foreign Application Priority Data
Jun. 12, 2002 (JP) 2002-171774

(51) Int. Cl. B26B 21/40

(52) U.S. Cl. 30/41

(57) ABSTRACT

An electric razor has a normal drive mode and a cleaning drive mode. The electric razor has a non-latch main switch, a driving unit for driving a blade of the razor, an indicator for notifying a user that the razor is operated in the cleaning drive mode, an indicator for prompting the user to perform cleaning, a timer for measuring a predetermined time, an integration timer for integrating a time during which the razor is operated in the normal drive mode, and a controller for controlling the operation of the driving unit, and for causing the indicators to emit light. The controller causes the timer to measure a time during which the main switch is in an ON-state, switches over the mode of the razor between the normal drive mode and the cleaning drive mode depending on a judgment result as to whether the ON-state time has reached a predetermined time, controls the blade to move at a speed suitable for shaving the beard while the razor is in the normal drive mode, and controls the blade to move at a speed suitable for cleaning the blade while the razor is in the cleaning drive mode.

### TECHNICAL FIELD

The present invention relates to an electric razor capable of cleaning a blade.

### BACKGROUND ART

Heretofore, there have been known electric razors capable of removing shaving debris adhering to the blades of the razors by washing the blades with water while driving the blades. In such an electric razor, the blade can be washed with water for cleaning by applying running water to the blade in a state that the inner blade and the outer blade are attached to the razor body. Further, applying a cleaning agent to the blade while driving the same makes it possible to more effectively clean the blade.

If, however, the blade has been left for a long time with shaving debris adhering thereto, it is more likely that the shaving debris firmly adheres to the inner blade, with the result that sufficient cleaning effect is not obtainable even if the blade is washed with water as mentioned above. There is known that a method of detaching the outer blade of the razor and applying running water directly to the inner blade while driving the inner blade provides sufficient cleaning effect, as a measure for such a case that the shaving debris has firmly adhered to the inner blade. Such a method, however, involves a drawback that the water and the shaving debris may be flicked off and scattered around the razor due to a relatively high-speed driving of the inner blade.

In view of the above, there has been proposed a method of using a dedicated cleaning vessel. According to the method, the electric razor body itself is accommodated in the cleaning vessel, and the inner blade is driven in a state that the portion of the razor to be cleaned is encased in the cleaning vessel. This method eliminates likelihood that the water and the shaving debris may be flicked off and scattered.

In the former method of detaching the outer blade of the razor and directly applying running water to the inner blade while driving the inner blade in an attempt to obtain sufficient cleaning effect, there is a drawback that the water and the shaving debris may be flicked off and scattered by the driving of the inner blade. In the latter method of using the dedicated cleaning vessel in an attempt to prevent scattering of the water and the shaving debris, the dedicated cleaning vessel is required to clean the blade of the electric razor. In the latter method, further, a large appliance is required as the cleaning vessel in light of the necessity that the cleaning vessel must enclose the cleaning portion of the electric razor, which obstructs easy cleaning of the electric razor.

### DISCLOSURE OF THE INVENTION

In view of the above problems residing in the prior art, it is an object of the present invention to provide an electric razor capable of effectively and easily cleaning a blade of the razor without scattering water and shaving debris.

The above object is accomplished by an electric razor provided with an inner blade and an outer blade to allow a user to shave hair such as beard, whiskers or mustache by nipping the hair between the inner blade and the outer blade while driving either or both the inner blade and the outer blade. The electric razor is operatively changeable between a normal drive mode of allowing the user to shave the hair, and a cleaning drive mode of allowing the user to clean the blade, wherein at least one of a driving frequency, the number of revolutions per unit time, and an amplitude of the blade in the cleaning drive mode is differentiated from a corresponding one in the normal drive mode.

### BRIEF DESCRIPTION OF THE DRAWINGS

FIG. 1 is an illustration showing an external appearance of an electric razor as a first embodiment of the present invention, as well as a manner as to how a blade portion is cleaned.

FIG. 2 is a block diagram of the electric razor as the first embodiment of the present invention.

FIG. 3 is an illustration showing a mode transition to explain an operation of the electric razor as the first embodiment of the present invention.

FIG. 4 is an illustration showing an external appearance of an electric razor as second and third embodiments of the present invention, as well as a manner as to how a blade portion is cleaned.

FIG. 5 is a block diagram of the electric razor as the second and third embodiments of the present invention.

FIG. 6 is a flowchart for explaining an operation of the electric razor as the second embodiment of the present invention.

FIG. 7 is a flowchart for explaining an operation of the electric razor as the third embodiment of the present invention.

### BEST MODE FOR CARRYING OUT THE INVENTION

The present invention will be illustrated in detail with embodiments, which, however, do not limit the invention. Adequate modification is allowable as far as it does not depart from the object of the present invention described above or below, and every such modification is intended to be embraced in the technical scope of the present invention. Arrangements equivalent to each other in the drawings will be denoted at the same reference numerals, and description thereof will be omitted herein.

### Construction of First Embodiment

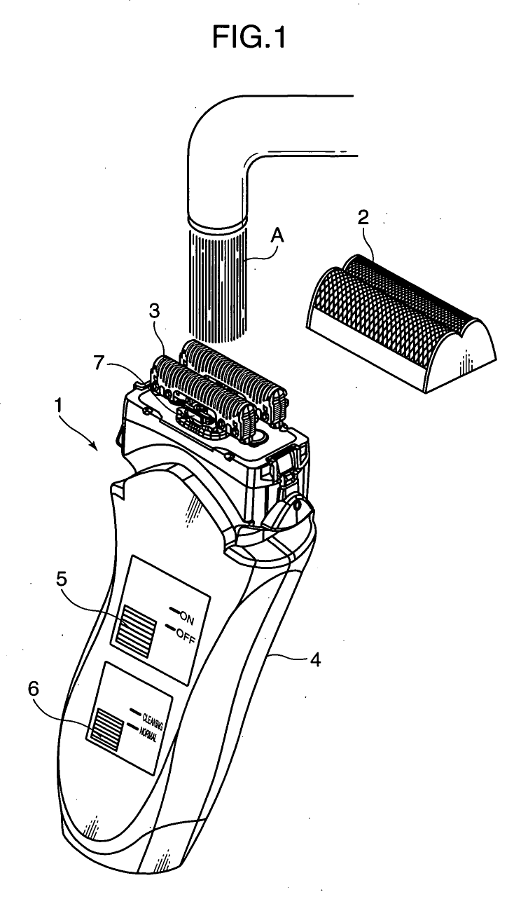

FIG. 1 is an illustration showing an external appearance of an electric razor 1 as a first embodiment of the present invention, as well as a manner as to how an outer blade 2 is detached from the electric razor 1, and an inner blade 3 is washed with running water A. A housing 4 of the electric razor 1 shown in FIG. 1 has a substantially rectangular column-like shape with a small thickness. The inner blade 3 is mounted on an upper surface at one end of the housing 4 via a driving unit 7. The outer blade 2 is mounted to the housing 4 in such a manner as to substantially cover the inner blade 3.

The outer blade 2 is detachably mountable by the user. When the outer blade 2 is mounted to the housing 4, the inner portion of the outer blade 2 is brought to sliding contact with the inner blade 3. FIG. 1 shows a state that the outer blade 2 is detached. Slidable switch handles 5 and 6 are provided on the front surface of the housing 4 in such a manner that each of the switch handles 5 and 6 is slidably movable up and down.

The switch handle 5 is a manipulating portion manipulated by the user to operate the electric razor 1. The switch handle 5 is slidably movable between two positions respectively corresponding to ON (close) state and OFF (open) state of the razor 1. The switch handle 6 is a manipulating portion manipulated by the user in selecting the operation mode of the electric razor 1. The switch handle 6 is slidable between two positions respectively corresponding to normal drive mode and cleaning drive mode.

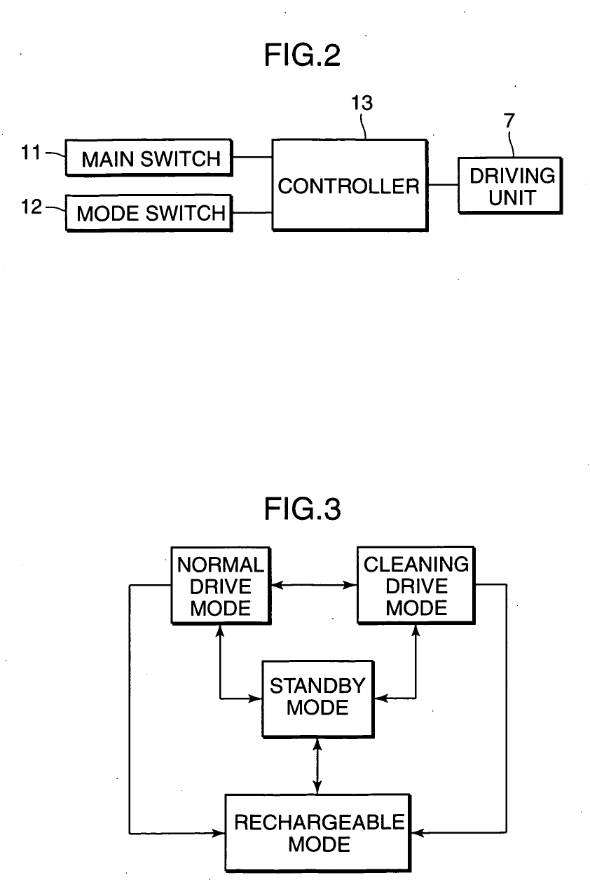

FIG. 2 is a block diagram of the electric razor 1 as the first embodiment of the present invention. A main switch 11 is turned on in response to sliding of the switch handle 5 to the ON position, and is turned off in response to sliding of the switch handle 5 to the OFF position. The ON/OFF signal of the main switch 11 is outputted to a controller 13.

A mode switch 12 is turned on in response to sliding of the switch handle 6 to the position corresponding to the cleaning drive mode, and is turned off in response to sliding of the switch handle 6 to the position corresponding to the normal drive mode. The ON/OFF signal of the mode switch 12 is outputted to the controller 13.

The controller 13 detects the ON/OFF signals outputted from the main switch 11 and the mode switch 12, and outputs a control signal to the driving unit 7 to control the operation of the driving unit 7 depending on the status of the ON/OFF signals outputted from the main switch 11 and the mode switch 12. The controller 13 comprises, for example, a CPU (Central Processing Unit), a ROM (Read Only Memory), and a RAM (Random Access Memory), and controls the operation of the driving unit 7, as the CPU executes a program stored in the ROM. A controller 14 (sic) may be composed of individual parts such as a logic circuit, a transistor, and an oscillating circuit, in place of the CPU or a like component.

The driving unit 7 is electrically connected with the inner blade 3, and drives the inner blade 3 to reciprocate the inner blade 3. The driving unit 7 is constituted by a linear motor, or a rotary motor, and a cam, for instance. The driving unit 7 is configured in such a manner that a driving frequency, which is the number of reciprocating the inner blade 3 per unit time, is variable depending on the control signal outputted from the controller 13, and that a driving amplitude, which is a moving distance of the inner blade 3 in one reciprocation, is set constant. In this arrangement, the moving speed of the inner blade 3 is proportional to the driving frequency. Further, the controller 13 is configured in such a manner that the moving speed of the inner blade 3 is controllable by controlling the driving frequency of the driving unit 7 based on the control signal.

Alternatively, the driving unit 7 may be configured in such a manner that the driving amplitude, which is the moving distance of the inner blade 3 in one reciprocation, is variable, with the driving frequency set constant, and the controller 13 may be configured in such a manner that the driving unit 7 controls the moving speed of the inner blade 3 by controlling the driving frequency of the driving unit 7 based on the control signal. Further alternatively, the controller 13 may be configured in such a manner that the driving unit 7 controls the moving speed of the inner blade 3 by controlling both the driving frequency and the driving amplitude.

The present invention is applicable to a rotary electric razor in which the inner blade is made rotatable. In such an altered arrangement, the driving unit 7 may be configured in such a manner that the number of revolutions, which is the number of rotating the inner blade 3 per unit time, is variable, and the controller 13 may control the moving speed of the inner blade 3 by controlling the number of revolutions of the driving unit 7 based on the control signal.

The controller 13 implements control in the normal drive mode of shaving beard, whiskers or mustache (hereinafter, simply called as “hair”), if the signal outputted from the mode switch 12 is in an OFF state, and the signal outputted from the main switch 11 is in an ON state.

Specifically, in the normal drive mode, the controller 13 outputs a control signal to the driving unit 7 to cause the driving unit 7 to reciprocate the inner blade 3 at a certain driving frequency, so that the inner blade 3 is driven at a moving speed suitable for shaving the hair. Reciprocating the inner blade 3 with the outer blade 2 mounted on the housing 4 makes it possible to shave the hair with the hair nipped between the inner blade 3 and the outer blade 2.

The controller 13 implements control in the cleaning drive mode of cleaning the blade portion, if the signal outputted from the mode switch 12 is in an ON state, and the signal outputted from the main switch 11 is in an ON state.

Specifically, in the cleaning drive mode, the controller 13 outputs a control signal to the driving unit 7 to cause the driving unit 7 to reciprocate the inner blade 3 at a certain driving frequency, so that the inner blade 3 is driven at a moving speed suitable for cleaning the inner blade 3.

For instance, in the case where cleaning is performed by detaching the outer blade 2, and directly applying running water A to the inner blade 3, the controller 13 sets the driving frequency of the driving unit 7 lower than the frequency in the normal drive mode to suppress scattering of the water and the shaving debris due to driving of the inner blade 3, so that the moving speed of the inner blade 3 driven by the driving unit 7 is set lower than the moving speed in the normal drive mode.

Various experiment results reveal that it is desirable to cause the controller 13 to control the operation of the driving unit 7 in such a manner that a maximum instantaneous moving speed of the inner blade 3 is set at 60 m or lower per minute to suppress scattering of the water and the shaving debris resulting from driving of the inner blade 3. In case of using the rotary electric razor in the present invention, it is desirable to cause the controller 13 to control the operation of the driving unit 7 in such a manner that the moving speed of the inner blade 3 at an outermost perimeter thereof is set at 60 m or lower per minute to suppress scattering of the water and the shaving debris.

It is desirable to cause the controller 13 to control the operation of the driving unit 7 in such a manner that the moving speed of the inner blade 3 instantaneously reaches 20 m or higher per minute in order to obtain sufficient cleaning effect by cleaning operation of directly applying running water A to the inner blade 3 while driving the inner blade 3. In such a case, it is desirable to cause the controller 13 to control the operation of the driving unit 7 in such a manner that the moving speed of the inner blade 3 reaches 20 m or higher per minute in the vicinity of the center of amplitude when the inner blade 3 is reciprocated at a possible maximum speed.

Alternatively, the controller 13 may control the driving frequency of the driving unit 7 to cause the driving unit 7 to drive the inner blade 3 in such a manner that the moving speed of the inner blade 3 in the cleaning drive mode is set higher than that in the normal drive mode, in a case that the blade portion is cleaned by applying water, a cleaning agent, or the like to the outer blade 2 as well as the inner blade 3, with the outer blade 2 attached to the housing 4 in order to enhance cleaning effect. In such an altered arrangement, since the inner blade 3 is driven at a higher moving speed, enhanced cleaning effect can be obtained. Furthermore, since the electric razor 1 is washed in a state that the outer blade 2 is mounted, it is less likely that the water and the shaving debris may be scattered.

Alternatively, the controller 13 may be provided with multiple drive modes as the cleaning drive mode in such a manner that the inner blade 3 is driven in the multiple drive modes where the moving speeds of the inner blade 3 are differentiated from each other. For instance, there are prepared a mode of driving the inner blade 3 at a high speed, a mode of driving the inner blade 3 at a low speed, and a mode of setting the moving speed of the inner blade 3 to zero, and the inner blade 3 is driven according to a combined order of the multiple drive modes in such a manner that the drive mode of the inner blade 3 is shifted from the high speed mode to the low speed mode quickly, or shifted from the high speed mode to the zero mode quickly, or these drive modes are repeated in an arbitrary combined order to vary the moving speed of the inner blade 3 stepwise, or to accelerate the moving speed of the inner blade 3. Such an altered arrangement is advantageous in obtaining high cleaning effect because the shaving debris is easily shaken off by the varied moving speed of the inner blade 3, the accelerated speed of the inner blade 3 or the like.

Furthermore, the electric razor 1 is provided with a rechargeable battery (not shown), and a charge control circuit (not shown) for controlling charge of the rechargeable battery. The charge control circuit is operative to switch over the mode of the electric razor 1 between a rechargeable mode of charging the rechargeable battery and an operation mode other than the rechargeable mode, depending on an output voltage of the rechargeable battery.

### Operation of First Embodiment

FIG. 3 is an illustration showing a mode transition to explain an operation of the electric razor 1 as the first embodiment of the present invention. Referring to the mode transition diagram of FIG. 3, standby mode indicates that the inner blade 3 is in an operation suspended state. When the switch handle 5 slides to the ON-position while the switch handle 6 is set to the position corresponding to the normal drive mode, an OFF-state signal is outputted from the mode switch 12 to the controller 13, and an ON-state signal is outputted from the main switch 11 to the controller 13. Thereby, the controller 13 is shifted from the standby mode to the normal drive mode.

In the normal drive mode, the controller 13 controls the driving frequency of the driving unit 7 to cause the driving unit 7 to drive the inner blade 3 at a moving speed suitable for shaving the hair.

On the other hand, in the case where the switch handle 5 slides to the ON-position while the switch handle 6 is set to the position corresponding to the cleaning drive mode, an ON-state signal is outputted from the mode switch 12 to the controller 13, and an ON-state signal is outputted from the main switch 11 to the controller 13. Thereby, the controller 13 is shifted from the standby mode to the cleaning drive mode.

In the cleaning drive mode, the controller 13 controls the driving frequency of the driving unit 7 to cause the driving unit 7 to drive the inner blade 3 in such a manner that the moving speed of the inner blade 3 is set lower than that in the normal drive mode, e.g., 20 m or higher per minute instantaneously, with a maximum instantaneous moving speed of 60 m or lower per minute. This arrangement is advantageous in effectively cleaning the inner blade 3 by detaching the outer blade 2 of the razor 1 and directly applying running water A to the inner blade 3, and in suppressing scattering of the water and the shaving debris. Further, this arrangement eliminates use of a dedicated washing vessel or a like appliance to wash the inner blade 3 and the like, thereby allowing the user to easily clean the blade of the electric razor 1.

On the other hand, in the case where the switch handle 6 slides to the position corresponding to the cleaning drive mode while the controller 13 is in the normal drive mode, and an ON-state signal is outputted from the mode switch 12, then, the controller 13 is shifted from the normal drive mode to the cleaning drive mode. Further, in the case where the switch handle 6 slides to the position corresponding to the normal drive mode while the controller 13 is in the cleaning drive mode, and an OFF-state signal is outputted from the mode switch 12, then, the controller 13 is shifted from the cleaning drive mode to the normal drive mode. Further, in the case where the switch handle 5 slides to the OFF-position while the controller 13 is in the normal drive mode or the cleaning drive mode, and an OFF-state signal is outputted from the main switch 11, then, the controller 13 is shifted from the normal drive mode (or the cleaning drive mode) to the standby mode. As a result, the driving unit 7 suspends driving of the inner blade 3.

### Construction of Second Embodiment

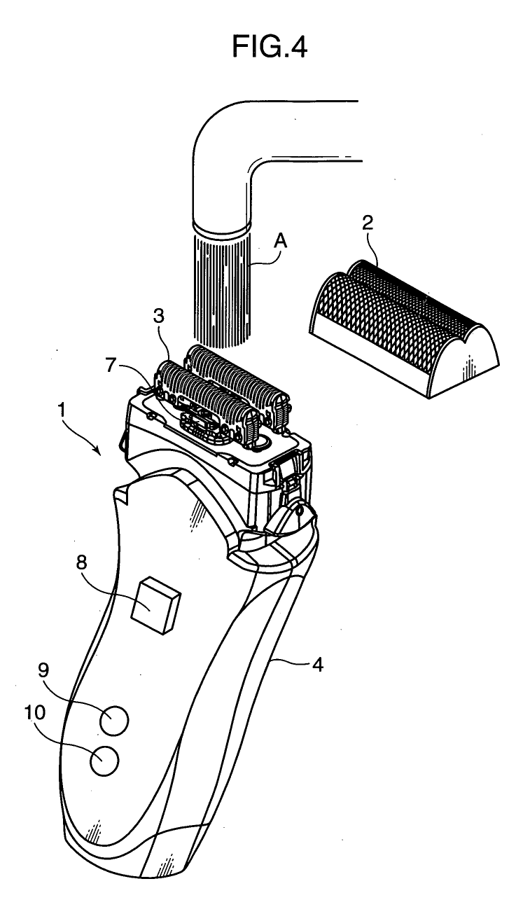

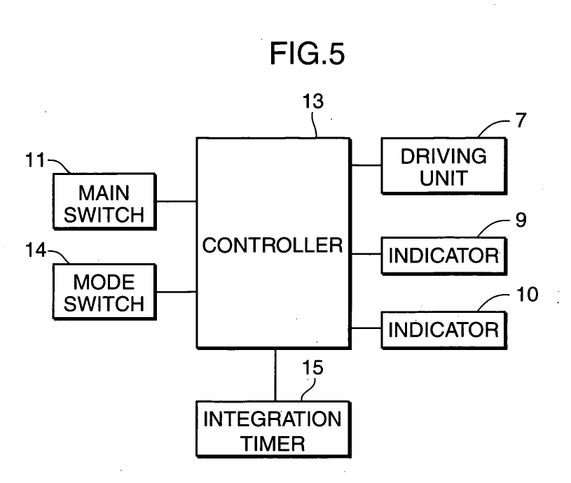

FIG. 4 is an illustration showing an external appearance of an electric razor 1 as a second embodiment of the present invention, as well as a manner as to how an outer blade 2 is detached, and an inner blade 3 is washed with running water A. FIG. 5 is a block diagram showing the electric razor 1 as the second embodiment of the present invention. The electric razor shown in FIG. 4 is different from the electric razor 1 shown in FIG. 1 in the following points.

Specifically, the electric razor 1 shown in FIG. 4 is not provided with slidable switch handles 5 and 6, and is provided with a switch button 8, an indicator 9, and an indicator 10 on the front surface of a housing 4. The switch button 8 is cooperatively connected with a main switch 11. In this example, a push button switch such as a non-latch tact switch is used as the main switch 11. The main switch 11 is so designed that it is kept in an ON-state while the user pushes the switch button 8, and is turned off in response to the user's release of the switch button 8.

The indicator 9 notifies the user that the electric razor 1 is operated in the cleaning drive mode by emitting light based on a signal outputted from a controller 13. The indicator 10 notifies the user of prompting cleaning by emitting light based on a signal outputted from the controller 13. The indicators 9 and 10 each is constituted of a light emitting diode, for instance.

The block diagram shown in FIG. 5 is different from the block diagram shown in FIG. 2 in the following points. Specifically, the arrangement shown in FIG. 5 is not provided with a mode switch 12, and is provided with a timer 14, an indicator 9, an indicator 10, and an integration timer 15. The timer 14 measures a time predefined by the controller 13. A general-purpose timer IC or the like is used as an example of the timer 14. The timer 14 starts measuring the time, and outputs a time-up signal to the controller 13 when the measured time has reached the time predefined by the controller 13.

The integration timer 15 reads out a signal which is outputted from the controller 13 and indicates that the razor 1 is operated in the normal drive mode, and integrates a time during which the signal is outputted. The integration timer 15 outputs an integration time-up signal to the controller 13 when the integration time has reached a predetermined T_{S}. The integration timer 15 resets the integration time to zero if the controller 13 outputs a signal indicating that the razor 1 is operated in the cleaning drive mode.

A timer IC operated by power supplied from a battery is used as an example of the integration timer 15. The integration time 15 holds (stores) the integration time even if the switch of the electric razor 1 is turned off, or the voltage of the rechargeable battery equipped in the electric razor 1 is lowered below a predetermined level. In the case where the controller 13 outputs, to the integration timer 15, a signal indicating that the razor 1 is operated in the normal drive mode, the integration timer 15 integrates a time during which the signal is outputted from the controller 13, in addition to the aforementioned stored integration time.

The controller 13 detects the status of the ON/OFF signal outputted from the main switch 11, sets a predetermined time Tₐ in the timer 14, and causes the timer 14 to measure the predetermined time Tₐ. The controller 13 judges whether the time during which the detected ON/OFF signal is kept in an ON state is not shorter than the predetermined time Tₐ measured by the timer 14, and switches over the mode of the electric razor 1 between the normal drive mode and the cleaning drive mode, based on a judgment result.

The controller 13 outputs a signal for causing the indicator 9 to emit light while a driving unit 7 drives the inner blade 3 in the cleaning drive mode, thereby causing the indicator 9 to emit light. With this arrangement, the user is notified that the electric razor 1 is operated in the cleaning drive mode by light emission of the indicator 9. Alternatively, the means for notifying the user that the electric razor 1 is operated in the cleaning drive mode may be alert means equipped with a buzzer or the like to alert the user by way of sound.

### Operation of Second Embodiment

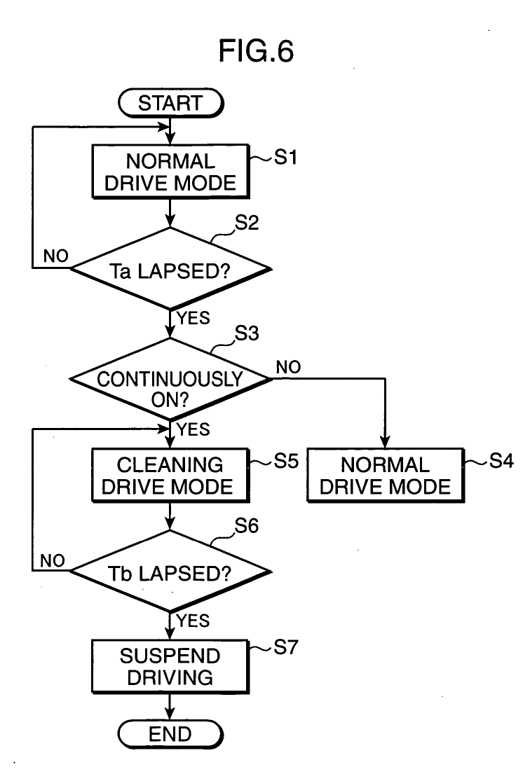

FIG. 6 is a flowchart for explaining the operation of the electric razor 1 as the second embodiment of the present invention. First, when the main switch 11 is turned on, the controller 13 outputs, to the driving unit 7, a control signal for controlling the driving unit 7 at a given driving frequency in the normal drive mode (Step S1). Then, the driving unit 7 drives the inner blade 3 in the normal drive mode, so that the inner blade 3 is controllably driven at a moving speed suitable for shaving the hair. Further, the controller 13 sets the predetermined time Tₐ in the timer 14, and the timer 14 starts measuring the predetermined time Tₐ.

As an altered form of Step S1, the controller 13 may control the driving unit 7 in such a manner that the moving speed of the inner blade 3 is set lower than the moving speed in the normal drive mode. In this case, it is desirable that the moving speed of the inner blade 3 at the time of starting driving is not lower than the moving speed in the cleaning drive mode and is lower than the moving speed in the normal drive mode. Such an altered arrangement is effective in suppressing scattering of the water and the shaving debris in the case where, for example, the main switch 11 is turned on while running water A is applied to the inner blade 3 in a state that the outer blade 2 has been detached.

Steps S1 and S2 are cyclically repeated to keep driving the inner blade 3 in the normal drive mode until the controller 13 detects the time-up signal outputted from the timer 14 (YES in Step S2). When the predetermined time Ta lapses, and the controller 13 detects the time-up signal outputted from the timer 14, the routine proceeds to Step S3.

In Step S3, if it is judged that the main switch 11 is kept in the ON-state (YES in Step S3), the routine goes to Step S5, so that the controller 13 implements control in the cleaning drive mode. If it is judged that the main switch 11 is not kept in the ON-state (NO in Step S3), the routine goes to Step S4, so that the controller 13 keeps control in the normal drive mode.

The controller 13 is switched over to the cleaning drive mode when the user continues to push the switch button 8 for the predetermined time Ta by the operations of Steps S2 and S3. In this embodiment, since the non-latch switch is used as the main switch 11 which is operated in cooperation with the switch button 8, the user is allowed to turn off the main switch 11 by merely releasing the hand from the switch button 8. The user is allowed to switch over the mode of the electric razor 1 to the normal drive mode by merely releasing the hand from the switch button 8 before lapse of the predetermined time Tₐ, thus making it possible to select the operation mode with a handy operation.

For instance, when the user applies a cleaning agent or the like from the outside of the outer blade 2 with the outer blade 2 mounted on the housing 4, pushes the switch button 8, and drives the inner blade 3 in the normal drive mode, then, the cleaning agent is spread over the entirety of the outer blade 2 and the inner blade 3 to make lather with the cleaning agent. In this case, since the inner blade 3 is driven at a moving speed higher than that in the cleaning drive mode, the cleaning agent can be more efficiently spread over, thus making lather with the cleaning agent efficiently.

If the user keeps pushing the switch button 8 for the predetermined time, the mode of the electric razor 1 is shifted to the cleaning drive mode. Thereafter, the user detaches the outer blade 2, and applies running water A directly to the inner blade 3, whereby cleaning is carried out with the cleaning agent being spread entirely over the inner blade 3, thus, providing enhanced cleaning effect. In detaching the outer blade 2, the user is required to temporarily release the hand from the switch button 8. In view of this, it is preferable to configure the controller 13 in such a manner that the cleaning drive mode is continued for a while once the mode is shifted to the cleaning drive mode, even if the user releases the hand from the switch button 8.

Further, in this embodiment, if the user releases the hand from the switch button 8 before the predetermined time Ta lapses after applying the cleaning agent, the mode of the electric razor 1 is shifted to the normal drive mode. This arrangement makes it possible to clean the electric razor 1 in the normal drive mode with the outer blade 2 mounted, as is the case with the conventional art. An example of the predetermined time Tₐ may range from about 2 to about 5 seconds, which is considered to be a time enough to spread the cleaning agent over the outer blade 2 and the inner blade 3.

As an altered arrangement, the routine may go to Step S4 to allow the controller 13 to implement control in the normal drive mode by skipping Step S3, if the main switch 11 is turned off before the predetermined time Tₐ lapses in Step S2. In such an altered arrangement, when the user releases the hand from the switch button 8 before the predetermined time Tₐ lapses, the routine promptly proceeds to Step S4 to drive the driving unit 7 in the normal drive mode without waiting for lapse of the predetermined time Tₐ.

Next, when the normal drive mode is set in Step S4, the controller 13 controls the driving frequency of the driving unit 7 in the normal drive mode. As a result, the driving unit 7 is driven at a moving speed suitable for shaving the hair. The controller 13 sets a predetermined time T_{S} in the integration timer 15.

Further, the controller 13 outputs, to the integration timer 15, a signal indicating that the driving unit 7 is driven in the normal drive mode, and the integration timer 15 integrates a time during which the signal is outputted. If the integration time exceeds the predetermined time T_{S}, the integration timer 15 outputs an integration time-up signal to the controller 13. Then, the controller 13 outputs a signal for causing the indicator 10 to emit light to prompt cleaning. Thus, the indicator 10 emits light.

An allowable time for accumulating the shaving debris in the blade portion has been empirically examined by having users shave the hair, and such a time is set as the predetermined time T_{S}. Alternatively, a switch or a like component for changing the predetermined time T_{S} may be provided, and the predetermined time T_{S} may be varied depending on user conditions such as whether the user is a heavy-bearded person. In such an altered arrangement, the user is notified that the shaving debris accumulated in the blade portion has reached the allowable limit, and the time to clean the razor 1 has come by way of light emission of the indicator 10.

On the other hand, referring back to Step S5, when the controller 13 is shifted to the cleaning drive mode, the controller 13 controls the driving frequency of the driving unit 7, so that the driving unit 7 drives the inner blade 3 at a moving speed suitable for cleaning the inner blade 3. Further, the controller 13 outputs a signal for causing the indicator 9 to emit light to notify the user that the razor 1 is operated in the cleaning drive mode.

Thus, the user can be notified that the razor 1 is operated in the cleaning drive mode by light emission of the indicator 9. This arrangement eliminates likelihood that the user may inadvertently shave the hair in the cleaning drive mode. Also, the user is guided to detach the outer blade 2 because the user can confirm that the operation mode of the razor 1 has been shifted to the cleaning drive mode by way of light emission of the indicator 9.

Alternatively, the indicator 9 may be omitted. In such an altered arrangement, the driving frequency for driving the inner blade 3 is changed by switching over the operation mode of the razor 1 to the cleaning drive mode, and the driving sound of the inner blade 3 is changed accordingly. Thus, the user can confirm that the mode has been switched over to the cleaning drive mode through the driving sound of the inner blade 3.

The controller 13 sets a predetermined time T_{b} in the timer 14, and the timer 14 starts measuring the predetermined time T_{b}. Further, the controller 13 outputs, to the integration timer 15, a signal indicating that the controller 13 is operated in the cleaning drive mode. Upon receiving the signal, the integration timer 15 resets the integration time to zero. This arrangement makes it possible to cause the integration timer 15 to integrate the time during which the user shaves the hair in the normal drive mode after cleaning the inner blade 3 in the cleaning drive mode, because the integration timer 15 resets the integration time to zero in response to driving of the inner blade 3 in the cleaning drive mode.

Steps S5 and S6 are cyclically repeated until the controller 13 detects the time-up signal outputted from the timer 14 (Step S6), and the driving of the inner blade 3 in the cleaning drive mode is continued for the predetermined time T_{b}. Upon lapse of the predetermined time T_{b}, and when the controller 13 detects the time-up signal outputted from the timer 14, the controller 13 causes the driving unit 7 to suspend the driving of the inner blade 3 (Step S7).

A time necessary for providing sufficient cleaning effect is set as the predetermined time T_{b}. In this way, sufficient cleaning effect is obtainable when the user performs cleaning in the cleaning drive mode.

Further, the driving of the inner blade 3 is automatically suspended by the controller 13 upon lapse of the time necessary for cleaning. In this arrangement, there is no need of the user's manipulating the razor 1 to suspend the driving of the inner blade 3. This arrangement eliminates likelihood that the blade is kept on being driven even in a case that the blade is brought to a state where the blade is driven in the cleaning drive mode against the user's intention. For instance, let us assume a case that the user carries the electric razor 1 in a bag or the like, and the switch button 8 is pushed against the user's intension, with the result that the blade is driven in the cleaning drive mode. In such a case, the above arrangement eliminates likelihood that the blade is kept on being driven, and prevents waste of the battery.

### Construction of Third Embodiment

An electric razor 1 as a third embodiment of the present invention is described. As is the case of the electric razor 1 as the second embodiment, FIG. 4 and FIG. 5 respectively show an external appearance and a block diagram of the electric razor 1 as the third embodiment of the present invention. The electric razor 1 as the third embodiment is different from the electric razor 1 as the second embodiment in the arrangement of the controller 13.

Specifically, in the third embodiment, there are provided, as the cleaning drive mode of the electric razor 1, a first cleaning drive mode of performing cleaning by applying a cleaning agent or the like from the outside of an outer blade 2 with the outer blade 2 mounted, and by spreading the cleaning agent entirely over the outer blade 2 and an inner blade 3, and a second cleaning drive mode of performing cleaning by detaching the outer blade 2, and applying running water to the inner blade 3.

In the first cleaning drive mode, the controller 13 controls the driving frequency of a driving unit 7, so that the driving unit 7 drives the inner blade 3 at a moving speed suitable for applying a cleaning agent or the like from the outside of the outer blade 2 with the outer blade 2 mounted, and spreading the cleaning agent entirely over the outer blade 2 and the inner blade 3.

In the above arrangement, since the outer blade 2 is mounted on a housing 4, there is no likelihood that the water and the shaving debris may be scattered, even if the moving speed of the inner blade 3 is set high. In view of this, it is desirable to set the moving speed of the inner blade 3 in driving the inner blade 3 in the first cleaning drive mode higher than that in the second cleaning drive mode in which cleaning is performed by applying running water to the inner blade 3 with the outer blade 2 detached. This arrangement is effective in spreading the cleaning agent or making lather with the cleaning agent. Alternatively, the moving speed of the inner blade 3 in driving the inner blade 3 in the first cleaning drive mode may be set equal to that in the second cleaning drive mode. Further alternatively, the moving speed of the inner blade 3 in driving the inner blade 3 in the first cleaning drive mode may be set equal to or higher than that in the normal drive mode.

In the second cleaning drive mode, the controller 13 controls the driving frequency of the driving unit 7 in such a manner that the driving unit 7 drives the inner blade 3 at a moving speed lower than that in the normal drive mode, e.g., instantaneously 20 m or higher per minute, with a maximum instantaneous moving speed of 60 m or lower per minute.

The controller 13 causes the driving unit 7 to drive the inner blade 3 in the first cleaning drive mode for a predetermined time T_{c}, followed by suspending the driving of the inner blade 3 for a predetermined time T_{d}. Thereafter, the controller 13 causes the driving unit 7 to drive the inner blade 3 in the second cleaning drive mode for a predetermined time Tₑ, followed by suspending the driving of the inner blade 3. In this arrangement, the user is allowed to apply a cleaning agent or the like from the outside of the outer blade 2 with the outer blade 2 mounted to spread the cleaning agent entirely over the outer blade 2 and the inner blade 3 while the razor 1 is operated in the first cleaning drive mode, and then, to detach the outer blade 3 easily during the predetermined time T_{d} while the driving of the inner blade 3 is suspended, and to clean the razor 1 by directly applying running water to the inner blade 3 with the cleaning agent having been spread over its entirety while the razor 1 is operated in the second cleaning drive mode.

In the above arrangement, the respective necessary times are predefined: the predetermined time T_{c}, which is a time sufficient for the user to apply the cleaning agent or the like from the outside of the outer blade 2 with the outer blade 2 mounted to spread the cleaning agent entirely over the outer blade 2 and the inner blade 3 or to make lather with the cleaning agent; the predetermined time T_{d}, which is a time sufficient for the user to detach the outer blade 2; and the predetermined time Te, which is a time sufficient to obtain satisfactory cleaning effect in the case where cleaning is performed by directly applying running water to the inner blade 3.

### Operation of Third Embodiment

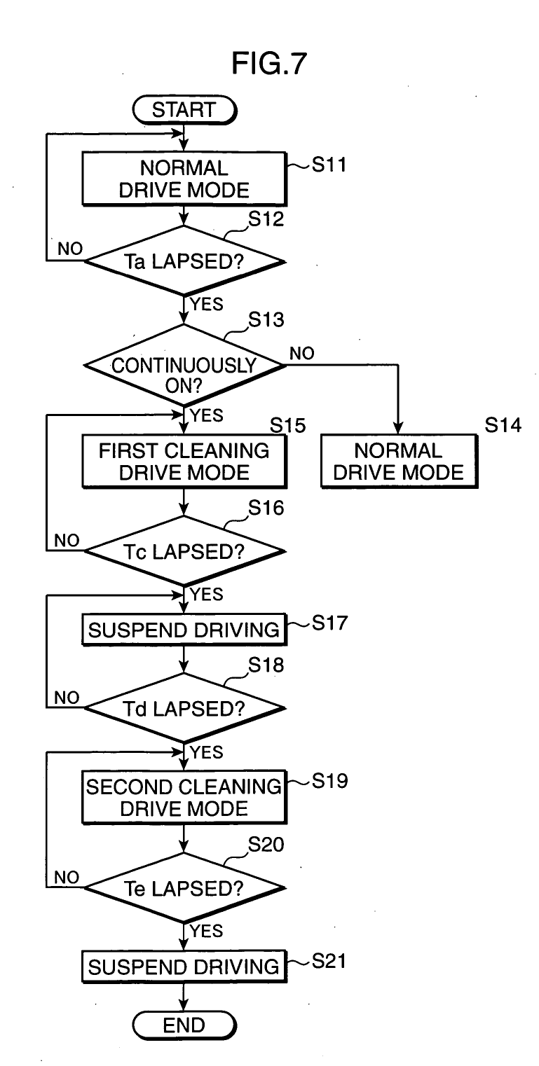

FIG. 7 is a flowchart for explaining the operation of the electric razor 1 as the third embodiment of the present invention. The third embodiment is different from the second embodiment in the operation of the electric razor 1 in the cleaning drive mode in Step S15 and thereafter in the flowchart of FIG. 7. Steps S11 through S14 in FIG. 7 are identical to Steps S1 through S4 in the flowchart of FIG. 6 showing the second embodiment, and accordingly, description thereof will be omitted herein, and the operation of Step S15 and thereafter will be described herein.

The routine goes directly from Step S13 to Step S15 to cause the controller 13 to implement control in the first cleaning drive mode. In Step S15, the controller 13 controls the driving frequency of the driving unit 7 in such a manner that the driving unit 7 drives the inner blade 3 at a moving speed suitable for spreading the cleaning agent entirely over the outer blade 2 and the inner blade 3, e.g., at a moving speed identical to that in the normal drive mode. This arrangement is advantageous in sufficiently spreading the cleaning agent over the entirety of the outer blade 2 and the inner blade 3 in applying the cleaning agent from the outside of the outer blade 2 with the outer blade 2 mounted, and driving the inner blade 3, because the inner blade 3 is driven at the moving speed higher than that of the inner blade 3 in driving the inner blade 3 in the second cleaning drive mode.

The controller 13 outputs a signal for causing the indicator 9 to emit light to notify the user that the razor 1 is in the cleaning drive mode, whereby the indicator 9 emits light. Further, the controller 13 sets the predetermined time T_{c} in the timer 14, and causes the timer 14 to start measuring the predetermined time T_{c}. A time required for sufficiently spreading the cleaning agent entirely over the outer blade 2 and the inner blade 3 is set as the predetermined time T_{c}, for example.

Steps S15 and S16 are cyclically repeated until the controller 13 detects the time-up signal outputted from the timer 14 (Step S16). In this way, the driving of the inner blade 3 in the first cleaning drive mode is continued for the predetermined time T_{c}. Upon lapse of the predetermined time T_{c}, and when the controller 13 detects the time-up signal outputted from the timer 14, the routine goes to Step S17 to suspend the driving of the inner blade 3.

In Step S17, the controller 13 causes the driving unit 7 to suspend the driving of the inner blade 3. Further, the controller 13 sets the predetermined time T_{d} in the timer 14, and causes the timer 14 to start measuring the predetermined time T_{d}.

Steps S17 and S18 are cyclically repeated until the controller 13 detects the time-up signal outputted from the timer 14 (Step S18), and the driving of the inner blade 3 is suspended for the predetermined time T_{d}. Upon lapse of the predetermined time T_{d}, and when the controller 13 detects the time-up signal outputted from the timer 14, the routine proceeds to Step S19 to cause the controller 13 to implement control in the second cleaning drive mode.

A time required for the user to detach the outer blade 2, for instance, is set as the predetermined time T_{d}. Thus, the user can easily detach the outer blade 2 without interference such as collision of the outer blade 2 with the inner blade 3, because the user can detach the outer blade 2 while the driving of the inner blade 3 is suspended.

Furthermore, when the driving of the inner blade 3 is suspended, the driving sound of the inner blade 3 ceases. Thus, the user can confirm that the driving of the inner blade 3 is suspended, and is prompted to detach the outer blade 2. Alternatively, the controller 13 may output a signal for causing the indicator 9 to blink light, whereby the indicator 9 blinks light while the driving of the inner blade 3 is suspended for the purpose of aiding the user to detach the outer blade 2.

Next, the routine goes to Step S19 to cause the controller 13 to implement control in the second cleaning drive mode. The controller 13 controls the driving frequency of the driving unit 7 in such a manner that the driving unit 7 drives the inner blade 3 at a moving speed lower than that in the normal drive mode, e.g., instantaneously 20 m or higher per minute, with a maximum instantaneous moving speed of 60 m or lower per minute. The controller 13 outputs a signal for causing the indicator 9 to emit light to notify the user that the razor 1 is in the cleaning drive mode, thereby emitting light of the indicator 9.

Further, the controller 13 sets the predetermined time Tₑ in the timer 14 to cause the timer 14 to start measuring the predetermined time Tₑ. Further, the controller 13 outputs, to the integration timer 15, the signal indicating that the razor 1 is in the cleaning drive mode. Upon receiving the signal the integration timer 15 resets the integration time to zero. Thus, in response to driving of the inner blade 3 in the second cleaning drive mode, the integration time integrated by the integration timer 15 is reset to zero. This arrangement makes it possible to allow the integration timer 15 to integrate a time during which the user shaves the hair in the normal drive mode after cleaning the inner blade 3 in the second cleaning drive mode.

Steps S19 and S20 are cyclically repeated until the controller 13 detects the time-up signal outputted from the timer 14 (Step S20), and the driving of the inner blade 3 in the second cleaning drive mode is continued for the predetermined time Tₑ. Upon lapse of the predetermined time Tₑ, and when the controller 13 detects the time-up signal outputted from the timer 14, the controller 13 causes the driving unit 7 to suspend the driving of the inner blade 3 (Step S21).

A time required for obtaining sufficient cleaning effect is set as the predetermined time Tₑ. This arrangement secures sufficient cleaning effect. Further, since the driving control by the controller 13 is automatically suspended upon lapse of the predetermined time Tₑ, there is no likelihood that the inner blade 3 is driven endlessly.

As mentioned above, according to an aspect of the present invention, an electric razor is provided with an inner blade and an outer blade to allow a user to shave hair such as beard, whiskers or mustache by nipping the hair between the inner blade and the outer blade while driving either or both the inner blade and the outer blade. The electric razor is operatively changeable between a normal drive mode of allowing the user to shave the hair, and a cleaning drive mode of allowing the user to clean the blade, wherein at least one of a driving frequency, the number of revolutions per unit time, and an amplitude of the blade in the cleaning drive mode is differentiated from a corresponding one in the normal drive mode.

In the electric razor thus constructed, the driving of the blade is controlled in the normal drive mode for allowing the user to shave the hair, and the driving of the blade is controlled in the cleaning drive mode for allowing the user to clean the blade, with at least one of the driving frequency, the number of revolutions, and the amplitude of the blade in the cleaning drive mode differentiated from the corresponding one in the normal drive mode. In this arrangement, since the moving speed of the blade is controlled to a value suitable for cleaning the blade while the razor is operated in the cleaning drive mode, the blade can be effectively cleaned. Further, in this arrangement, since there is no need of cleaning the blade by using an appliance, the blade can be cleaned with a handy operation.

Preferably, the present invention has a feature that at least one of the driving frequency, the number of revolutions, and the amplitude of the blade in the cleaning drive mode is set smaller than the corresponding one in the normal drive mode. According to the above arrangement, at least one of the driving frequency, the number of revolutions, and the amplitude of the blade in the cleaning drive mode is set smaller than the corresponding one in the normal drive mode. Namely, the moving speed of the blade in the cleaning drive mode is set lower than that in the normal drive mode. This arrangement is advantageous in suppressing scattering of water and shaving debris in the case where cleaning is performed by detaching the outer blade of the razor and driving the blade in the cleaning drive mode while directly applying water to the inner blade.

Preferably, the present invention has a feature that a maximum instantaneous moving speed of the blade is set at 60 m or lower per minute, and at least one of the moving speeds of the blade is instantaneously set at 20 m or higher per minute in the cleaning drive mode. Thus, in the cleaning drive mode, the maximum instantaneous moving speed of the blade is set at 60 m or lower per minute, and at least one of the moving speeds of the blade is set at 20 m or higher per minute instantaneously. In the above arrangement, while the blade is driven in the cleaning drive mode by detaching the outer blade of the razor and directly applying running water to the inner blade, the maximum instantaneous moving speed of the blade is maintained at a speed not higher (sic) than a speed at which scattering of water and shaving debris becomes untolerable. Further, at least one of the moving speeds of the blade instantaneously attains a speed capable of effectively cleaning the blade. This arrangement is advantageous in performing effective cleaning while suppressing scattering of water and shaving debris.

Preferably, the present invention has a feature that at least one of the driving frequency, the number of revolutions, and the amplitude of the blade in the cleaning drive mode is set larger than the corresponding one in the normal drive mode. Thus, at least one of the driving frequency, the number of revolutions, and the amplitude of the blade in the cleaning drive mode is set larger than the corresponding one in the normal drive mode. Namely, the moving speed of the blade in the cleaning drive mode is higher than that in the normal drive mode. This arrangement is advantageous in effectively cleaning the blade in the case where cleaning is performed by applying a cleaning agent or the like to the blade with the outer blade mounted and driving the blade.

Preferably, the present invention has a feature that the cleaning drive mode includes multiple drive modes, at least one of the driving frequency, the number of revolutions, and the amplitude of the blade in the one of the multiple drive modes is differentiated from the corresponding one in the other one of the multiple drive modes, and the blade is driven in a combined order of the multiple drive modes. Thus, the cleaning drive mode is provided with the multiple drive modes, at least one of the driving frequency, the number of revolutions, and the amplitude of the blade in one of the multiple drive modes is differentiated from the corresponding one in the other one of the multiple drive modes, and the blade is driven in a combined order of the multiple drive modes. In this arrangement, since the shaving debris is shaken off by combining the multiple drive modes in which the moving speeds of the blade are differentiated from each other, and by varying the moving speed of the blade, more effective cleaning can be carried out.

Preferably, the present invention has a feature that the electric razor is operated in the normal drive mode in response to turning on of a switch, and is switched over to the cleaning drive mode if a time of the ON-state of the switch is continued for a predetermined time. In the electric razor thus constructed, the blade is driven in the normal drive mode in response to turning on of the switch, and the razor is switched over to the cleaning drive mode if a time of the ON-state of the switch exceeds the predetermined time. Thus, since the razor is switched over to the cleaning drive mode if the user continues to turn on the switch for a period of not shorter than the predetermined time, there is no need of additionally providing a switch for operating the razor in the cleaning drive mode.

Preferably, the present invention has a feature that driving of the blade is suspended after the blade is driven in the cleaning drive mode for a predetermined time. In the electric razor thus constructed, the driving of the blade is suspended after the blade is driven in the cleaning drive mode for the predetermined time. In this arrangement, since the driving of the blade is suspended upon lapse of the predetermined time even if the blade is brought to a state where the blade is driven in the cleaning drive mode against the user's intention, there is no likelihood that the driving of the blade is continued against the user's intension.

Preferably, the present invention has a feature that driving of the blade is suspended after the blade is driven for a first duration, and the driving of the blade is resumed upon lapse of a second duration after the suspension of the driving of the blade while the electric razor is operated in the cleaning drive mode. In the electric razor thus constructed, after the blade is driven for the first duration in the cleaning drive mode, the driving of the blade is suspended for the second duration, followed by resuming of the driving of the blade. This arrangement enables the user to detach the outer blade while the driving of the blade is suspended. Accordingly, the user is allowed to detach the outer blade easily without interference such as collision of the outer blade with the inner blade in detaching the outer blade.

Preferably, the present invention has a feature that at least one of the driving frequency, the number of revolutions, and the amplitude of the blade after the driving of the blade is resumed is differentiated from the corresponding one before the driving of the blade is suspended while the electric razor is operated in the cleaning drive mode. In the electric razor thus constructed, at least one of the driving frequency, the number of revolutions, and the amplitude of the blade after the driving of the blade is resumed is differentiated from the corresponding one before the driving of the blade is suspended. This arrangement enables to control the moving speed of the blade so as to satisfy a case where cleaning is performed by applying a cleaning agent to the outer blade and the inner blade with the outer blade mounted before the driving of the blade is suspended, and a case where cleaning is performed by detaching the outer blade, and driving the inner blade after the driving of the blade is resumed.

Preferably, the present invention has a feature that at least one of the driving frequency, the number of revolutions, and the amplitude of the blade after the driving of the blade is resumed is set smaller than the corresponding one before the driving of the blade is suspended while the electric razor is operated in the cleaning drive mode. In the electric razor thus constructed, at least one of the driving frequency, the number of revolutions, and the amplitude of the blade after the driving of the blade is resumed is set smaller than the corresponding one before the driving of the blade is suspended. This arrangement is advantageous in suppressing scattering of water and shaving debris in the case where cleaning is performed by detaching the outer blade and driving the blade while directly applying running water to the inner blade after the driving of the blade is resumed.

Preferably, the present invention has a feature that after the driving of the blade is resumed, the driving of the blade is suspended after the blade is driven for a third duration while the electric razor is operated in the cleaning drive mode. In the electric razor thus constructed, after the driving of the blade is resumed, the blade is driven for the third duration, followed by suspension of the driving of the blade. This arrangement eliminates likelihood that the blade is kept on being driven, even if the blade is brought to a state where the blade is driven in the cleaning drive mode against the user's intension, because the driving of the blade is suspended upon lapse of the third duration.

Preferably, the present invention has a feature that the blade is driven with at least one of the driving frequency, the number of revolutions, and the amplitude of the blade at the time of turning on of the switch smaller than the corresponding one in the normal drive mode, the blade is driven in the cleaning drive mode if it is judged that the ON-state time of the switch has reached a predetermined time, and the blade is driven in the normal drive mode if it is judged that the ON-state time of the switch has not reached the predetermined time, and in response to turning off of the switch. In the electric razor thus constructed, the blade is driven with at least one of the driving frequency, the number of revolutions, and the amplitude of the blade at the time of turning on of the switch smaller than the corresponding one in the normal drive mode, the blade is driven in the cleaning drive mode if it is judged that the ON-state time of the switch has reached the predetermined time, and the blade is driven in the normal drive mode if it is judged that the ON-state time of the switch has not reached the predetermined time, and in response to turning off of the switch. In this arrangement, the moving speed of the blade at the time of turning on of the switch is set lower than that in the normal drive mode. This arrangement is advantageous in suppressing scattering of water and shaving debris at a time including immediately after the switch is turned on, even if the blade is cleaned with the outer blade detached by the user.

Preferably, the electric razor of the present invention further comprises notifying means for notifying the user that the electric razor is operated in the cleaning drive mode. In the electric razor thus constructed, while the razor is in the cleaning drive mode, the user is notified by the notifying means that the razor is operated in the cleaning drive mode. This arrangement enables to notify the user that the razor is operated in the cleaning drive mode while the razor is in the cleaning drive mode.

Preferably, the electric razor of the present invention further comprises indicating means for integrating a time during which the blade is driven in the normal drive mode after the blade is driven in the cleaning drive mode, and for prompting the user to clean the blade if it is judged that the integration time has reached a predetermined time. In the electric razor thus constructed, the indicating means integrates the time during which the blade is driven in the normal drive mode after the blade has been driven in the cleaning drive mode, and prompts the user to clean the electric razor if it is judged that the integration time has reached the predetermined time. This arrangement enables to prompt the user to clean the razor at an appropriate time when the shaving debris has substantially been accumulated.

### EXPLOITATION IN INDUSTRY

The present invention has the arrangement as mentioned above. The present invention provides a handy electric razor capable of efficiently cleaning a blade without using an appliance for cleaning the blade, and of suppressing scattering of water and shaving debris, because the razor is provided with the normal drive mode of allowing the user to shave hair, and a cleaning drive mode of allowing the user to clean the blade portion.

1. An electric razor provided with an inner blade and an outer blade to allow a user to shave hair such as beard, whiskers or mustache by nipping the hair between the inner blade and the outer blade while driving either or both the inner blade and the outer blade, the electric razor being operatively changeable between a normal drive mode of allowing the user to shave the hair, and a cleaning drive mode of allowing the user to clean the blade, wherein at least one of a driving frequency, the number of revolutions per unit time, and an amplitude of the blade in the cleaning drive mode is differentiated from a corresponding one in the normal drive mode.

2. The electric razor according to claim 1, wherein at least one of the driving frequency, the number of revolutions, and the amplitude of the blade in the cleaning drive mode is set smaller than the corresponding one in the normal drive mode.

3. The electric razor according to claim 1, wherein a maximum instantaneous moving speed of the blade is set at 60 m or lower per minute, and at least one of the moving speeds of the blade is instantaneously set at 20 m or higher per minute in the cleaning drive mode.

4. The electric razor according to claim 1, wherein at least one of the driving frequency, the number of revolutions, and the amplitude of the blade in the cleaning drive mode is set larger than the corresponding one in the normal drive mode.

5. The electric razor according to claim 1, wherein the cleaning drive mode includes multiple drive modes, at least one of the driving frequency, the number of revolutions, and the amplitude of the blade in the one of the multiple drive modes is differentiated from the corresponding one in the other one of the multiple drive modes, and the blade is driven in a combined order of the multiple drive modes.

6. The electric razor according to claim 1, wherein the electric razor is operated in the normal drive mode in response to turning on of a switch, and is switched over to the cleaning drive mode if a time of the ON-state of the switch is continued for a predetermined time.

7. The electric razor according to claim 1, wherein driving of the blade is suspended after the blade is driven in the cleaning drive mode for a predetermined time.

8. The electric razor according to claim 1, wherein driving of the blade is suspended after the blade is driven for a first duration, and the driving of the blade is resumed upon lapse of a second duration after the suspension of the driving of the blade while the electric razor is operated in the cleaning drive mode.

9. The electric razor according to claim 8, wherein at least one of the driving frequency, the number of revolutions, and the amplitude of the blade after the driving of the blade is resumed is differentiated from the corresponding one before the driving of the blade is suspended while the electric razor is operated in the cleaning drive mode.

10. The electric razor according to claim 9, wherein at least one of the driving frequency, the number of revolutions, and the amplitude of the blade after the driving of the blade is resumed is set smaller than the corresponding one before the driving of the blade is suspended while the electric razor is operated in the cleaning drive mode.

11. The electric razor according to claim 8, wherein after the driving of the blade is resumed, the driving of the blade is suspended after the blade is driven for a third duration while the electric razor is operated in the cleaning drive mode.

12. The electric razor according to claim 1, wherein the blade is driven with at least one of the driving frequency, the number of revolutions, and the amplitude of the blade at the time of turning on of the switch smaller than the corresponding one in the normal drive mode, the blade is driven in the cleaning drive mode if it is judged that the ON-state time of the switch has reached a predetermined time, and the blade is driven in the normal drive mode if it is judged that the ON-state time of the switch has not reached the predetermined time, and in response to turning off of the switch.

13. The electric razor according to claim 1, further comprising notifying means for notifying the user that the electric razor is operated in the cleaning drive mode.

14. The electric razor according to claim 1, further comprising indicating means for integrating a time during which the blade is driven in the normal drive mode after the blade is driven in the cleaning drive mode, and for prompting the user to clean the blade if it is judged that the integration time has reached a predetermined time.
